(19) United States
(12) Patent Application Publication
(10) Pub. No.: US 2004/0123471 A1
(43) Pub. Date: Jul. 1, 2004

(54) Ergonomic knife

(76) Inventor: Kenneth J. Onion, Kaneohe, HI (US)

Correspondence Address: KOLISCH HARTWELL, P.C., 520 S.W. YAMHILL STREET, SUITE 200, PORTLAND, OR, 97204, US

(21) Appl. No.: 10/637,951

(22) Filed: Aug. 7, 2003

Related U.S. Application Data
(60) Provisional application No. 60/402,012, filed on Aug. 7, 2002.

(51) Int. Cl. B26B 3/00

(52) U.S. Cl. 30/340; 30/298

(57) ABSTRACT

A knife is provided including a blade and an ergonomic handle attached to the blade. The handle may include a palm-engaging portion and a contoured belly portion with a stabilizing node. The handle may further include guide members disposed on opposing sides of the front end of the handle, wherein the guide members provide an engagement surface for a user's thumb and forefinger.

### CROSS-REFERENCE TO RELATED APPLICATIONS

This application claims priority to U.S. Provisional Patent Application Serial No. 60/402,012, filed Aug. 7, 2002 for a KNIFE, the disclosure of which is hereby incorporated by reference.

### BACKGROUND

The present invention relates generally to knives, and more specifically to a knife with an ergonomic handle. Kitchen knives and related knives and components thereof are disclosed in a number of U.S. patents, including U.S. Pat. Nos. 6,564,685, 6,487,948, 6,263,581, 4,955,139, 4,811,642, 5,442,856, 5,251,380, and 4,203,213, the disclosures of which are hereby incorporated by reference for all purposes. Ergonomic handles for tools are disclosed in a number of U.S. patents, including U.S. Pat. Nos. 6,213,055 and 6,418,820.

### SUMMARY

A knife is provided including a blade and an ergonomic handle attached to the blade. The handle may include a palm-engaging portion and a contoured belly portion with a stabilizing node. The handle may further include guide members disposed on opposing sides of the front end of the handle, wherein the guide members provide an engagement surface for a user's thumb and forefinger.

The advantages of the present invention will be understood more readily after a consideration of the drawings and the Detailed Description.

### BRIEF DESCRIPTION OF THE DRAWINGS

FIG. 1 is a rear perspective view of a knife, according to one embodiment of the present disclosure.

FIG. 2 is a view of the side of the knife shown in FIG. 1.

FIG. 3 is a view of the opposing side of the knife shown in FIG. 2.

FIG. 4 is a rear view of the knife shown in FIG. 1.

FIG. 5 is a front view of the knife shown in FIG. 1.

FIG. 6 is a top view of the knife shown in FIG. 1.

FIG. 7 is a bottom view of the knife shown in FIG. 1.

FIG. 8 is an illustration of the knife of FIG. 1 held in a user's hand.

### DETAILED DESCRIPTION

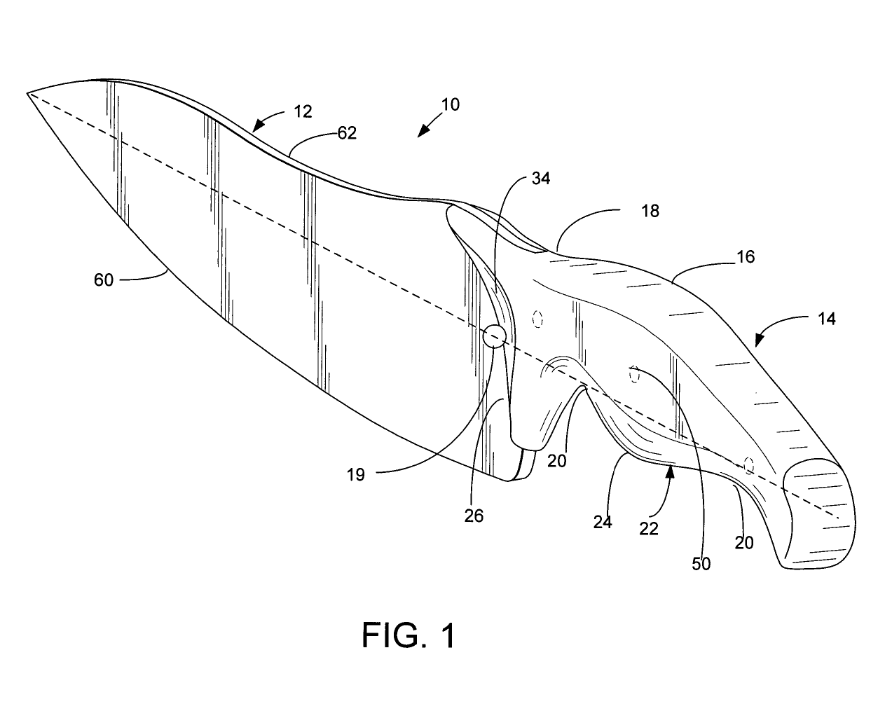

Referring to the drawings, and more specifically to FIG. 1, a knife 10 according to one embodiment of the present disclosure is shown. The knife includes a cutting blade 12 attached to an ergonomic handle 14 adapted to be gripped by a user. The configuration of the knife and handle reduces stress on a user's hand and increases cutting productivity during use.

Although knife 10 is illustrated as a general-purpose kitchen knife, it should be appreciated that the knife may be any suitable type of knife or like tool with a handle and a blade. For example, knife 10 may be a paring knife, a steak knife, a folding knife, a retractable knife, a bread knife, a saw, etc. It should further be noted that the knife may be used for cutting, slicing, chopping, sawing, etc.

In the illustrated embodiment shown in FIG. 1, handle 14 is an ergonomic handle configured to reduce cutting stress and to maximize cutting productivity. The handle includes a grip that substantially matches the natural contours of a user's hand. Specifically, handle 14 includes an arched back portion 16 along the upper edge of the handle. The arched back portion may be adapted to rest within the palm, or inner surface of a user's hand. The position of the arched back portion matches the raised surface of a user's palm enabling a user to wrap their hand in an efficient use-position (also referred to herein as a natural gripping position) on the handle.

In some embodiments, the arched back portion 16 may further define an indent 18 configured to enable a user to position their hand in a forward position where the user's hand is positioned adjacent the rear of the blade. Such a position may be useful during chopping due to the additional control of the user on the blade.

In some embodiments, knife 10 may have a balance point 19 at which the handle weight equals the blade weight. As described in more detail below, the contours of the handle, including the combination of an arched back portion 16 and indent 18, may enable a user to selectively position their hand relative balance point 19 such that their hand is in a desired or position allowing maximum leverage and control of the knife during use.

Handle 14 is further configured to enable a user to wrap his/her fingers substantially around the handle. Grooves or recesses 20 in the underside, or belly portion 22, of the handle are provided for a user's fingers. The grooves enable a user to firmly grip the handle preventing a user's hand from slipping off of the handle during use. The arrangement of the grooves enables the fingers and hand of a user to be arranged in a substantially fixed cutting/operation position. In such a position, the user does not need to constantly readjust/reposition their hand and/or fingers during cutting.

In some embodiments, the grooves may be adjacent a stabilizing node 24. Stabilizing node 24 typically is an outwardly-extending ridge or bump which may split a user's fingers such that the handle is locked within the user's grip. Some users may wrap one or more fingers, such as a middle finger or ring finger, around stabilizing node 24 and the region adjacent to stabilizing node 24. Stabilizing node 24 and the region adjacent stabilizing node may effectively position a user's hand on the knife in the operation or use position, such that the knife is prevented from slipping, twisting, or becoming unstable within a user's grip. Stabilizing node 24 may further be used to control the pressure on the blade during cutting, chopping, slicing, etc. For example, a user may the blade rock forward and backward in a cutting motion by changing the pressure on stabilizing node 24.

Grooves 20 and stabilizing node 24 form a contoured belly portion that may correlate to the natural curves of a user's fingers when the hand is in a cupped or gripping position. The user does not need to strain their fingers to engage the handle. In contrast, the contoured belly portion may be comfortably gripped without loss of control on the knife. Such a configuration may function to minimize hand fatigue and increase speed of cutting and stability of the knife during cutting. Although stabilizing node 24 is shown as a rounded protuberance from the belly of the handle, it should be appreciated that other configurations are possible for stabilizing node, including a detent, slight angle or sharply-angled protuberance.

Handle 10 may further include guide members, such as cutouts or scallops 34. Cutouts 34 may be disposed toward the front end of the handle, angling into the rear end 26 of blade 12. Cutouts 34 may be adapted such that in a neutral position, a user positions their thumb on one side of the handle in a first side cutout and their forefinger on a second side cutout disposed on the opposing side of the handle. The cutouts may be shaped to conform to the shape of a user's forefinger and thumb pads. Typically, cutouts 34 are concave or rounded to provide a comfortable contact surface. Positioning of the thumb and forefinger (or index finger) in such cutouts may enable a user to position their handle in a natural neutral position, which may decrease hand-fatigue during use of the knife.

In some embodiments, the cutouts may enable a user to alter the effective balance of the knife. For example, if the balance point of the knife is located at point 19 or substantially adjacent the intersection of the blade and the handle, cutouts 34, which may be disposed in close proximity to the balance point, may enable a user to operate the knife from a neutral position. Thus, the user may selectively control motion of the knife. By increasing and decreasing pressure on the handle, thus changing the balance of the knife, the user may cause the knife to travel in a desired motion, such as rocking, chopping, cutting, etc.

A user may selectively raise and lower the position of their forefinger or thumb within the cutouts. Altering the position of their forefinger and/or thumb within the cutouts may enable a user to adjust the type and amount of motion of the knife during use. For example, in the illustrated embodiment, a user may select a handle heavy position, a neutral position, or a blade heavy position. In a neutral position, a user may dispose their thumb and forefinger substantially adjacent balance point 19. In a handle heavy position (blade light position), the user may dispose their thumb/fingers in cutouts 34 above balance point 19. Alternatively, in a blade heavy position (handle light position), the user may dispose their thumb/fingers in cutouts 34 below balance point 19. Thus, a user may selectively change the effective weight of the handle relative to the blade. The ability to selectively change the balance/weight of the knife may enable the knife to be used for a variety of cutting tasks. Moreover, the cutouts may accommodate a user's cutting grip and style.

Although shown as scalloped or angled cutouts, it should be noted that the cutouts may be of any suitable size and shape to adapt to different-sized user's hands. In the embodiment illustrated, the cutouts are angled at 35 to 45 degrees from the handle side surface, however, any suitable angle may be used to define the cutouts.

Referring briefly to FIG. 6, it should be appreciated that handle 14 may be a variable width handle that corresponds to the natural contours of a cupped hand. As illustrated, the handle may include a wide central region and tapered ends configured to enable the user to lock the handle in their natural grip. For example, a front portion 42 of the handle may be a first width 44, and the rear portion 46 may be a second width 48. Typically, the front and rear are configured to correspond to the cupped hand such that a user may securely grip the knife. In some embodiments, the width of the front portion may be substantially identical to the width of the rear portion. Alternatively, the width of the front portion may be less than or greater than the width of the rear portion.

Interposed the front and rear portion of the handle may be a palm swell or bulge 50 having a width 52. Width 52 may be greater than the front handle width or the rear handle width such that the girth of the middle of the knife is larger than both the front and rear portions. Thus, palm swell 50 may define a mid-handle portion that bulges out from the front and rear of the handle. The configuration of palm swell 50 is such that the bulging portion may be adapted to rest within the palm, or inner surface of a user's hand. Typically, palm swell 50 is adapted to conform to the inside cup-shape of a user's hand when in a gripping position. For example, the space formed when a user cups their hand in a gripping position may be filled by the palm swell, thus providing support for the user's palm. The variable girth of the handle may function to stabilize a user's hand on the knife, decreasing fatigue, maximizing control and preventing slippage of the user's hand from the knife. The combination of the palm swell and the arched back portion form the palm-engaging portion of the knife.

The configuration of the knife may enhance the rolling-sliding motion, rocking motion or chopping motion that may be used when repetitively cutting, such as repetitively cutting vegetables or other food products. As described briefly above, the handle configuration positions the user's hand in close proximity to the end of the blade 26. When the user applies pressure to the front portion of the knife, the front portion of the handle of the knife rocks forward. Similarly, as the pressure is removed, the knife rocks backward, thus engaging and disengaging the blade of the knife against a desired cutting surface. Similarly, when cutting, the hand may be positioned in a forward position, adapted to aid in smooth cutting of material.

When the blade is disengaged, the user may slide a cutting product substantially perpendicular to the blade, thereby positioning the product for another cut. The configuration of the knife augments the rocking motion, while maintaining the user's hand in a substantially fixed position. This substantially fixed position, may further be a neutral position allowing the knife to be balanced and the user to selectively control the balance of the knife during operation of the knife. The handle shape, thus, promotes positioning of the hand in a neutral, substantially fixed position, which may enable a user to make successive cuts without fatigue.

The blade cutting edge (or lower blade edge) 60 also may be shaped to facilitate and/or enhance the rocking motion, cutting motion, etc. For example, the cutting edge may be curved or arched such that a first edge portion rests again a cutting surface when a user's hand is in the neutral, balanced position on the handle. By altering the balance of the handle, the knife may rock forward and/or backward along the cutting edge 60.

The knife may further be used at an angle without loss of control. For example, a user may maintain the operation grip when cutting or chopping material at a desired angle, such as a 45-degree angle. Although the knife may be angled, the user's hand may remain substantially fixed on the handle without loss of control. For example, the user's hand may be substantially fixed in an operation/use position with the thumb and forefinger in cutouts 34, middle finger on stabilizing node 24 and the palm engaging back portion 16 and palm swell 50.

It should be noted that in some embodiments, blade 12 may further include a shaped upper edge 62. Upper edge 62 typically is wider than cutting edge 60. Upper edge 62 may be shaped and broadened such that a user may apply hand pressure to the edge. For example, upper edge 62 may be flattened and/or curved to enable a user to press downwards on upper edge 62 with their hand. A user applying downward pressure to the blade may cause the blade to cut, chop or slice materials which require additional cutting force. For example, a user may apply pressure to upper edge 62 when cutting dense materials, such as frozen products.

It should be appreciated that in some embodiments, the user may extend their thumb along back portion 16 of handle 14 and/or blade 12. Such a configuration may enable a user to apply additional pressure to upper edge 62. For example, a user may position their thumb of their gripping hand along detent 18 or upper edge 62. The user may then apply pressure to the base of the blade, causing the blade to rock backwards.

The blade also may include a multi-purpose tip 64. Multi-purpose tip 64 may be configured to puncture or aid in the removal of packaging from meat or other products. To use the knife as a puncture tool, the knife may be in a reverse/upside down orientation, where the knife is flipped over (or reversed) such that upper edge 62 is the lowermost edge. The tip may then be forced into a wrap or package, thus puncturing the wrap. The blade may be slid into the puncture and slid along the underside of the wrap, thereby cutting the wrap with cutting edge 60. In such a reverse orientation, upper edge 62 of the blade harmlessly slides over the product while cutting edge 60 cuts the wrap or packaging.

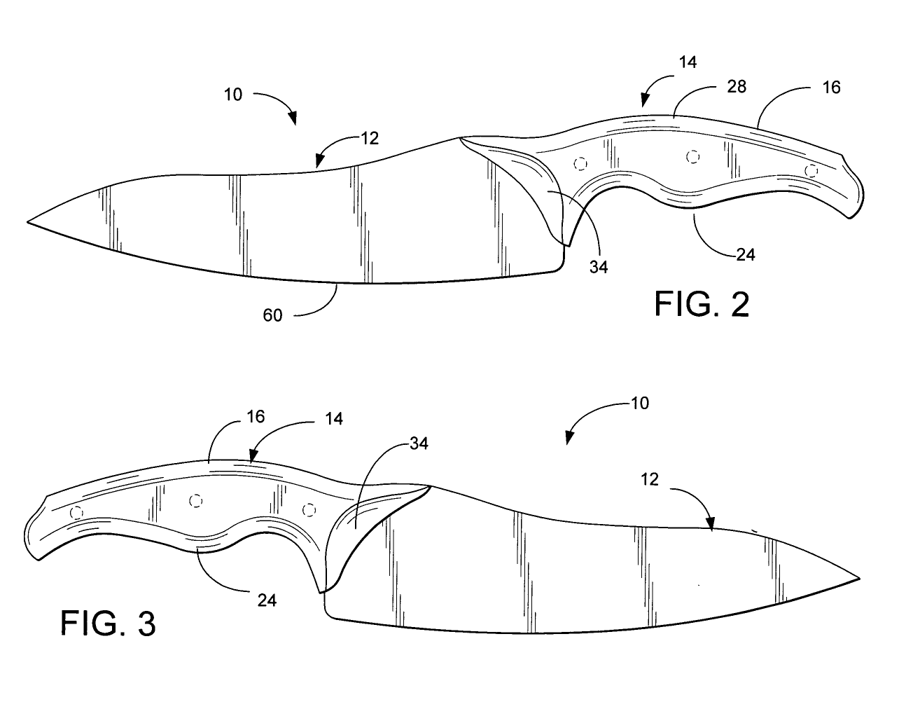

FIGS. 2-7 further illustrate the knife shown in FIG. 1. Specifically, FIGS. 2 and 3 show side views of the knife. As described above, handle 14 includes a longitudinally-extending back portion 16 with a slow-rising arch 28 (shown in FIG. 2). In some embodiments, the handle may extend from the upper portion of the blade and be smaller in dimension than the blade. Moreover, in some embodiments, the handle may be disposed above the cutting edge 60 of the blade, thereby spacing the user's hand from the cutting surface during cutting.

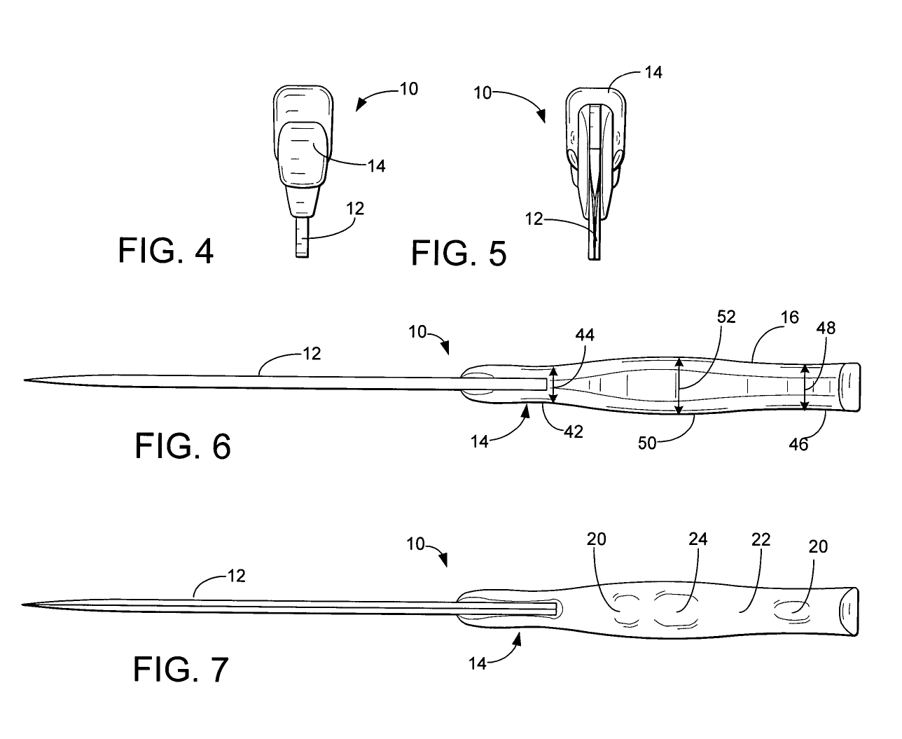

FIGS. 4 and 5 show respectively a rear view and a front view of the knife shown in FIG. 1. FIG. 4 clearly illustrates the position of the handle relative to the blade whereby the handle extends above the cutting edge of the blade. Such a configuration provides for a balanced knife, where the balance point is substantially adjacent the intersection of the blade and knife. Moreover, a user may grip the knife, and without stress, rock, cut or chop material with the knife. The position of the handle above the cutting edge of the blade may enable a user to use the entire length of the blade during cutting without the handle interfering with operation of the blade.

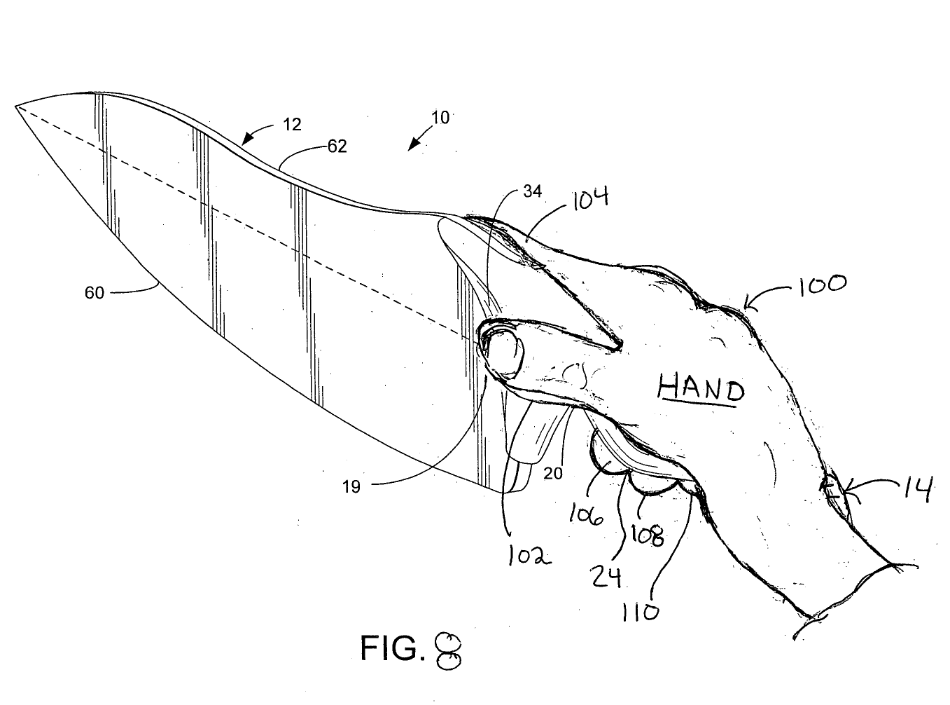

FIGS. 6 and 7 respectively show a top and bottom view of the knife shown in FIG. 1. As described above, FIG. 6 illustrates the arched back portion or upper surface 16 and the variable width/girth of the handle. FIG. 7 further illustrates the variable width/girth of the handle, the contoured belly of the handle. Variable width portions, such as palm swell 50, correspond to the natural contours of a user's hand, thus supporting the arch of a user's hand when in a cupped position. The variable girth and arched back may further enable a user to position their hand in a forward natural gripping position on the handle.

FIGS. 6 and 7 further illustrate that the handle may have a variable girth enabling a user to more firmly and securely grip the handle. As illustrated, the handle may include a wide central region and tapered ends configured to enable the user to lock the handle in their natural grip.

The configuration of the handle promotes the use of the knife by a variety of users. Specifically, arched back portion 28 may be shaped to accommodate different-sized hands. For example, the arched back portion may be received within the palm of a user such that the palm substantially engages palm swell 50 regardless of the size of the user's hand. Similarly, cutouts 34 and grooves 20 are sized such that a variety of different-sized hands may be accommodated without loss of control of the knife.

FIG. 8 is an illustration of the knife of FIG. 1 held in a user's hand. It should be noted that the hand position shown in FIG. 8 is intended as an illustration of one of the many possible positions that may be used to hold knife 10 and such illustration is not intended as a limitation. As shown in the illustration, knife 10 includes a blade 10 and a handle 14. User's hand 100 is shown positioned in a gripping position on the handle. Specifically, the palm of the user's hand may rest on the arched back portion of the handle. The cupped palm may extend around palm swell 50 such that the hand is fully engaged against the handle.

The user may position thumb 102 along cutout 34. Similarly, the user may position forefinger 104 against the cutout on the opposing side of the knife. As discussed above, the thumb/forefinger may be substantially aligned with the balance point 19 of the knife. Such that the hand is in a neutral position relative the knife. By altering the position of the thumb and forefinger, the user may change the effective balance of the knife.

The user may wrap their middle finger 106, ring finger 108 and pinky 110 around the belly or underside 22 of handle 14. Specifically, middle finger 106 and/or ring finger 108 may be wrapped around stabilizing node 24. Thus, the handle follows the general contours of the hand providing a natural position for the hand on the handle.

Although the invention has been disclosed in its preferred forms, the specific embodiments thereof as disclosed and illustrated herein are not to be considered in a limiting sense, because numerous variations are possible. The subject matter of the invention includes all novel and non-obvious combinations and subcombinations of the various elements, features, functions, and/or properties disclosed herein. No single feature, function, element or property of the disclosed embodiments is essential. The following claims define certain combinations and subcombinations of features, functions, elements, and/or properties that are regarded as novel and nonobvious. Other combinations and subcombinations may be claimed through amendment of the present claims or presentation of new claims in this or a related application. Such claims, whether they are broader, narrower, equal, or different in scope to any earlier claims, also are regarded as included within the subject matter of the invention.

We claim:

1. A knife comprising:
a blade; and
a handle coupled to the blade, wherein the handle has a front end and a rear end, the handle further includes an arched back portion and a palm swell interposed the front end and rear end where the arched back portion and the palm swell substantially conform to a palm of a user's hand when the user's hand is in a gripping position.

2. The knife of claim 1, further comprising guide members disposed on opposing sides of the front end of the handle, wherein the guide members provide an engagement surface for a user's thumb and forefinger.

3. The knife of claim 2, wherein the guide members are scalloped-shaped.

4. The knife of claim 2, wherein the guide members substantially correspond to a balance point of the knife.

5. The knife of claim 2, wherein the guide members enable a user to position their hand in a neutral position on the handle.

6. The knife of claim 4, wherein the guide members are elongated such that a user may change effective balance of the knife by altering the position of their thumb and forefinger relative the balance point of the knife.

7. The knife of claim 1, wherein the handle has a contoured belly.

8. The knife of claim 1, wherein the handle has a belly including a stabilizing node.

9. The knife of claim 8, wherein the stabilizing node protrudes from the belly of the knife.

10. The knife of claim 8, wherein the stabilizing node is adapted to be gripped by at least one of a user's fingers.

11. The knife of claim 7, wherein the belly includes at least one groove.

12. The knife of claim 1, wherein the blade has a curved cutting edge.

13. The knife of claim 1, wherein the blade has a shaped upper edge adapted for contact by a hand of a user.

14. An ergonomic handle for a knife, the handle comprising:
an arched back portion for receiving a user's palm;
a front end of a first width;
a rear end of a second width; and
a palm swell interposed the front end and the rear end, where the palm swell is wider than the first width and the second width such that the palm swell substantially corresponds to the user's palm.

15. The ergonomic handle of claim 14, further comprising a contoured belly portion including a stabilizing node.

16. The ergonomic handle of claim 14, further comprising a scalloped region angling from the front end of the handle to a blade, where the scalloped region is adapted to position a user's thumb and forefinger in an operational position.

17. A knife comprising:
a blade; and
an ergonomic handle attached to the blade, the handle including a palm-engaging portion and a contoured belly portion with a stabilizing node.

18. The knife of claim 17, wherein the handle further includes a first side and a second side, where the first side has a first guide member and the second side has a second guide member such that a user's hand may be disposed in a substantially fixed operational position.

19. The knife of claim 18, wherein the first guide member and second guide member are scalloped regions extending from the handle to the blade and adapted to position a user's thumb and forefinger in an operational position.

20. The knife of claim 19, wherein the scalloped region substantially corresponds to a balance point of the knife such that the hand may be selectively disposed in a neutral position.
